(19) United States
(12) Patent Application Publication
(10) Pub. No.: US 2024/0001592 A1
(43) Pub. Date: Jan. 4, 2024

(54) METHOD AND APPARATUS FOR PROVIDING A FIBER-REINFORCED COMPOSITE MATERIAL

(71) Applicant: VICTREX MANUFACTURING LIMITED, Thornton Cleveleys, Lancashire (GB)

(72) Inventors: Zhongwei Guan, Liverpool, Merseyside (GB); Alireza Moradi, Liverpool, Merseyside (GB)

(21) Appl. No.: 18/249,923

(22) PCT Filed: Oct. 22, 2021
(86) PCT No.: PCT/GB2021/052741

§ 371 Date: Apr. 20, 2023

(30) Foreign Application Priority Data
Oct. 23, 2020 (GB) 2016847.2

(51) Int. Cl. B29B 15/12

(52) U.S. Cl. CPC B29B 15/122; B29K 2105/162

(57) ABSTRACT

A method of providing a fibre-reinforced composite material, the method comprising: dispersing particles of a first polymeric composition comprising a first thermoplastic in a liquid comprising water, thereby forming a dispersion; coating, at least in part, a first set of reinforcement fibres with the dispersion; redistributing the particles of the first polymeric composition comprised in the coating; and melting at least some of the redistributed particles of the first polymeric composition comprised in the coating, thereby providing the composite material.

### FIELD

The present invention relates to the fibre reinforced composite materials, for example pre-pregs.

### BACKGROUND TO THE INVENTION

Pre-pregs are fibre reinforced composite materials in which reinforcement fibres are pre-impregnated with a thermoplastic resin or a thermoset, such as epoxy, matrix and are intended for subsequent shaping, for example moulding. The reinforcement fibres may be unidirectional or woven, for example, and the resin or matrix bonds the reinforcement fibres together during manufacture of the pre-pregs. Thermoplastic resin pre-pregs are typically hot-shaped. The thermoset matrices of pre-pregs are only partially cured to facilitate handling and these B-Stage materials typically require cold storage to prevent complete curing. After subsequent shaping, such thermoset matrix pre-pregs are thermally cured.

Some thermoplastic polymers, such as polyaryletherketones (PAEKs), have high mechanical strength and high temperature stability, for example having continuous operating temperatures of 250° C. and may withstand transient temperatures of up to 350° C. However, such thermoplastic polymers typically have high melt viscosities, thereby limiting application of such thermoplastic polymers for fibre reinforced composite materials. Desirably, the reinforcement fibres are uniformly distributed in the fibre reinforced composite material, with the thermoplastic polymer resin uniformly surrounding all the reinforcement fibres (i.e. uniform impregnation), and no porosity. However, conventional methods of providing fibre-reinforced composite materials may result in non-uniform distribution of the reinforcement fibres in the fibre reinforced composite materials, non-uniform impregnation and/or porosity, thereby degrading mechanical properties thereof and in turn, of articles formed therefrom. Generally, porosity is of concern because the pores or voids substantially reduce mechanical properties of the fibre reinforced composite materials and in turn, of articles formed therefrom. Porosity may arise from trapped air and/or volatiles used during processing of the fibre reinforced composite materials. Low-viscosity resins, vacuum outgassing, and consolidation all help reduce porosity.

Hence, there is a need to improve fibre reinforced composite materials, for example pre-pregs. For example, there is a need to address the difficulties and high costs associated with manufacturing thermoplastic prepregs, particularly when utilising high melt viscosity polymers in the manufacturing.

### SUMMARY OF THE INVENTION

It is one of the aims of the present invention, amongst others, to provide a fibre reinforced composite material which at least partially obviates or mitigates some of the disadvantages of the prior art. For instance, it is an aim of embodiments of the invention to provide a method of providing a fibre reinforced composite material that improves impregnation of reinforcement fibres by thermoplastics. For instance, it is an aim of embodiments of the invention to provide an apparatus for providing fibre reinforced composite materials that facilitates manufacture thereof. For instance, it is an aim of embodiments of the invention to provide a fibre reinforced composite material having improved mechanical properties. It is one aim of the present invention, amongst others, to provide an economical and practical method of manufacturing unidirectional thermoplastic prepreg material which at least partially obviates or mitigates at least some of the disadvantages of the prior art, whether identified herein or elsewhere. For instance, it is an aim of embodiments of the invention to provide a thermoplastic prepreg manufacturing method that benefits from easy impregnation of fibre reinforcement with thermoplastic resin via a spreading/impregnation device to produce unidirectional prepreg by method of drum winding.

A first aspect provides a method of providing a fibre-reinforced composite material, the method comprising:
dispersing particles of a first polymeric composition comprising a first thermoplastic in a liquid comprising water, thereby forming a dispersion;
coating, at least in part, a first set of reinforcement fibres with the dispersion; redistributing the particles of the first polymeric composition comprised in the coating; and
melting at least some of the redistributed particles of the first polymeric composition comprised in the coating, thereby providing the composite material.

A second aspect provides an apparatus for providing a fibre-reinforced composite material, the apparatus comprising:
means for coating, at least in part, a first set of reinforcement fibres with a dispersion comprising particles of a first polymeric composition comprising a first thermoplastic in a liquid comprising water;
means for redistributing the particles of the first polymeric composition comprised in the coating; and
means for melting at least some of the redistributed particles of the first polymeric composition comprised in the coating, thereby providing the composite material.

A third aspect provides a fibre-reinforced composite material comprising a first set of reinforcement fibres, surrounded by a first polymeric composition comprising a first thermoplastic polymer; wherein a volume fraction of the first set of fibres is in a range from 50% to 70% by volume of the composite material; optionally wherein the polymeric composition comprises a filler, for example a nanomaterial such as a 2D material or a nanoclay, in a range from 1 wt. % to 10 wt. % by weight of the composite material.

### DETAILED DESCRIPTION OF THE INVENTION

According to the present invention there is provided a method, as set forth in the appended claims. Also provided is an apparatus and a fibre-reinforced composite material. Other features of the invention will be apparent from the dependent claims, and the description that follows.

### Method

A first aspect provides a method of providing a fibre-reinforced composite material, the method comprising:
dispersing particles of a first polymeric composition comprising a first thermoplastic in a liquid comprising water, thereby forming a dispersion;
coating, at least in part, a first set of reinforcement fibres with the dispersion;
redistributing the particles of the first polymeric composition comprised in the coating; and
melting at least some of the redistributed particles of the first polymeric composition comprised in the coating, thereby providing the composite material.

In this way, uniformity of impregnation is improved, such that the first polymeric composition more uniformly surrounds the reinforcement fibres of the first set thereof while more uniformly distributing the reinforcement fibres of the first set thereof in the fibre reinforced composite material, compared with conventional methods. By improving the uniformity of impregnation and distribution of the reinforcement fibres, porosity is reduced. Furthermore, since the first polymeric composition is dispersed in the liquid comprising water, for example an aqueous solution, high melt viscosity thermoplastics may be used, since the redistributing of the particles of the first polymer composition comprised in the coating is independent of the melt viscosity of the first thermoplastic. Additionally and/or alternatively, relatively high fibre volume fractions V_{f}may be achieved with uniform impregnation. In this way, the mechanical properties of the fibre reinforced composite material are improved and in turn, of articles formed therefrom.

Particularly, by coating the first set of reinforcement fibres with the aqueous dispersion comprising particles of the first polymeric composition, the particles penetrate between the reinforcement fibres and are deposited thereupon as a coating. Subsequently, these deposited particles in the coating are redistributed, thereby improving uniformity of distribution thereof, before melting.

Additionally and/or alternatively, the method according to the first aspect and/or the apparatus according to the second aspect relates to the concept, design and manufacture processes of a novel drum winding thermoplastic prepreg rig capable of manufacturing unidirectional thermoplastic prepreg using an aqueous dispersion of thermoplastic powder with control over fibre/polymer ratio, e.g. weight and volume fraction of constituents and fibre spread, e.g. areal weight and thickness, with ability to uniformly embed nanomaterials to manufacture fibre-reinforced nanocomposites.

### Fibre-Reinforced Composite Material

The method is of providing the fibre-reinforced composite material. In one example, the fibre-reinforced composite material comprises and/or is a pre-preg or a laminate formed therefrom. In one example, the fibre-reinforced composite material comprises and/or is a ribbon, a tape or a sheet, for example a unidirectional ribbon, a unidirectional tape or a unidirectional sheet.

### Dispersing

The method comprises dispersing the particles of the first polymeric composition comprising the first thermoplastic in the liquid comprising water, thereby forming the dispersion.

In one example, dispersing the particles comprises suspending the particles in the liquid, wherein the dispersion comprises and/or is a suspension of the particles in the liquid. In one example, dispersing the particles in the liquid comprises forming a paste or a slurry using a part of the liquid and subsequently, adding the remaining liquid and mixing, for example by stirring using an impeller, static mixing and/or vibrating, for example ultrasonically. In one example, dispersing the particles in a liquid comprises adding the particles to the liquid and mixing. In one example, dispersing the particles in the liquid comprises dispersing the particles in the liquid at a temperature in a range from 5° C. to 50° C., preferably in a range from 10° C. to 40° C., more preferably in a range from 15° C. to 30° C., for example 20° C. or 25° C., for example room temperature.

In one example, the first thermoplastic comprises and/or is an amorphous polymer having a glass transition temperature T_{g}≥80° C. In one example, the first thermoplastic comprises and/or is an semi-crystalline polymer having a melting temperature T_{f}≥150° C.

In one example, the first thermoplastic is selected from a group comprising:
polymers and copolymers of the polyamide family (PA), such as high density polyamide, polyamide 6 (PA-6), polyamide 11 (PA-11), polyamide 12 (PA-12), polyamide 6.6 (PA-6.6), polyamide 4,6 (PA-4,6), polyamide 6.10 (PA-6.10), polyamide 6.12 (PA-6.12), aromatic polyamides, optionally modified by urea units, for example polyphthalamides and aramid, and block copolymers for example polyamide/polyether;
polyureas, for example aromatic polyureas;
polymers and copolymers of the acrylic family such as polyacrylates, for example polymethyl methacrylate (PMMA) or derivatives thereof;
polymers and copolymers of the polyarylether ketone family (PAEK) such as polyetherketone (PEK), polyetheretherketone (PEEK), polyetherketone ketone (PEKK), polyetherketoneetherketoneketone (PEKEKK) and polyetherimide (PEI) or aromatic polyetherimides (PEI) or derivatives thereof;
polyarylsulfides, for example polyphenylene sulfides (PPS);
polyarylsulfones, for example polyphenylene sulfones (PPSU);
polyolefins, for example polypropylene (PP);
polylactic acid (PLA);
polyvinyl alcohol (PVA);
fluorinated polymers, in particular polyvinylidene fluoride (PVDF), or polytetrafluoroethylene (PTFE) or polychlorotrifluoroethylene (PCTFE);
and mixtures thereof.

In one example, the first thermoplastic comprises and/or is a semi-crystalline polymer having a melting temperature T_{f}≥150° C. and is selected from a group comprising:
polyamides (PA), in particular aromatic polyamides optionally modified by urea repeat units and the copolymers thereof;
polymethyl methacrylate (PPMA) and the copolymers thereof;
polyetherimides (PEI);
polyphenylene sulfide (PPS);
polyphenylene sulfone (PPSU);
polyaryletherketones (PAEK), such as polyetherketone (PEK), polyetheretherketone (PEEK), polyetherketoneketone (PEKK), polyetherketoneetherketoneketone (PEKEKK) and polyetherimide (PEI);
and/or fluorinated polymers such as polyvinylidene fluoride (PVDF).

For fluorinated polymers, a homopolymer of vinylidene fluoride (VDF of formula CH₂═CF₂) may be used, or a VDF copolymer comprising at least 50 weight % VDF and at least one other monomer copolymerisable with VDF. To improve mechanical properties, particularly at relatively higher temperatures, the VDF content is at least 70 wt. %, preferably at least 80 wt. % or preferably at least 90 wt. %, by weight of the copolymer. The comonomer may be a fluorinated monomer such as vinyl fluoride.

Polyaryletherketones (PAEKs), such as polyetherketone (PEK), polyetheretherketone (PEEK), polyetherketoneketone (PEKK), polyetherketoneetherketoneketone (PEKEKK) and polyetherimide (PEI), provide good mechanical properties, including at relatively high temperatures.

In one example, the first thermoplastic is selected from a group comprising acrylonitrile butadiene styrene (ABS), polylactic acid (PLA), polycarbonate (PC), polyamide (PA), polystyrene (PS), high-density polyethylene (HDPE), PC/ABS, polyethylene terephthalate (PETG), polyphenylsulfone (PPSU), high impact polystyrene (HIPS), polytetrafluoroethylene (PTFE), lignin, rubber, and/or a polyaryletherketone (PAEK), such as polyetherketone (PEK), polyetheretherketone (PEEK), polyetherketoneketone (PEKK), polyetherketoneetherketoneketone (PEKEKK) and polyetherimide (PEI).

In one preferred example, the first thermoplastic is a PAEK, such as polyetherketone (PEK), polyetheretherketone (PEEK), polyetherketoneketone (PEKK), polyetherketoneetherketoneketone (PEKEKK) and polyetherimide (PEI), or a derivative thereof or a mixture thereof.

In one example, the first polymeric composition comprises a reactive thermoplastic resin, such as Elium®. Elium is a liquid monomer that may be processed like a thermoset but upon reaction, transforms into a thermoplastic which may be subsequently thermoformed, melted and/or welded. Anionic polymerization of caprolactam (a monomer of polyamide-6, PA-6) is also suitable. Generally, reactive thermoplastic resins may be cured after laying, for example by heating and/or using a catalyst included in the first polymeric composition, thereby reacting molecules thereof to provide a thermoplastic having improved mechanical properties.

In one example, the particles of the first polymeric composition have a median diameter D50 in a range from 1 μm to 100 μm, preferably in a range from 2.5 μm to 75 μm, more preferably in a range from 5 μm to 60 μm, most preferably in a range from 7.5 μm to 15 μm, for example 10 μm. In one example, the particles of the first polymeric composition have a D10 in a range from 4 μm to 6 μm for example about 5 μm, D50 in a range from 7 μm to 13 μm for example about 10 μm and D90 in a range from 15 μm to 25 μm for example about 20 μm. In this way, a relatively more homogeneous dispersion of the particles in the dispersion and/or a relatively more uniform distribution of the particles in the coating may be achieved.

Polymer particle size of the same order as the fibre diameter is beneficial as it eases the penetration of PAEK polymers, for example, between the fibre filaments. Too large particles cannot fully impregnate the fibre bundle and therefore are not suitable. For instance, after the wet fibre tow is passed on the fibre spreader/impregnation rollers, the force exerted on the wet fibre might not be able to fully push the particle in the central parts of the fibre bundle.

Too small particles (less than 5 microns) are expensive to mill and manufacture. Usually, powders with diameter of 5 microns or less simulate bigger particle sizes in the range of 20 microns by agglomeration. Therefore, as a compromise, powders with a median particle diameter of about 10 to 20 microns should be suitable for 9-micron S2-glass fibre filaments. More generally, in one example, the median diameter D50 of the particles is about the diameter d_{f} of the reinforcement fibres, for example in a range from 0.5d_{f} to 4d_{f}, preferably in a range from 0.75d_{f} to 3d_{f}, more preferably in a range from d_{f} to 2d_{f}.

Particle size distributions of the particles (and hence median diameter D50) may be determined using a Saturn DigiSizer 5200 (Micromeritics, US), operated according to the manufacturer's instructions. The particle size distribution of a sample is obtained by detecting a light scattering pattern when the sample is suspended in a specific carrier, for example an aqueous solution of 0.4% sodium hexametaphosphate (for example prepared using 6.7 g sodium hexametaphosphate and 1.3 g sodium hydrogen carbonate for 2 L deionized water). Alternatively, a Malvern Instruments MASTERSIZER may be used. Three sample replicates are typically measured.

In one example, the first polymeric composition comprises a second thermoplastic, different from the first thermoplastic, generally as described with respect to the first thermoplastic.

In one example, the method comprises dispersing particles of a second polymeric composition comprising a third thermoplastic in the liquid, different from the first polymeric composition, generally as described with respect to the first polymeric composition, wherein the third thermoplastic is the same as or different from the first thermoplastic, generally as described with respect to the first thermoplastic.

In one example, the liquid comprises water in a range from 80 wt. % to 100 wt. %, preferably in a range from 85 wt. % to 99 wt. %, more preferably in a range from 90 wt. % to 97.5 wt. %, by weight of the liquid. That is, the dispersion is an aqueous dispersion, thereby improving safety and/or environmental impact, compared with organic liquids.

In one example, the liquid comprises a dispersion agent, a thickening agent, a viscosity regulating agent, a resinous agent, a surfactant, or a mixture thereof, in a range from 0 wt. % to 20 wt. %, preferably in a range from 1 wt. % to 15 wt. %, more preferably in a range from 2.5 wt. % to 10 wt. %, by weight of the liquid.

In one example, the liquid comprises a dispersion agent in a range from 0 wt. % to 20 wt. %, preferably in a range from 1 wt. % to 15 wt. %, more preferably in a range from 2.5 wt. % to 10 wt. %, by weight of the liquid. In this way, a relatively more homogeneous dispersion of the particles in the dispersion may be achieved, for example by reducing particle agglomeration, and/or a relatively more stable dispersion, for example such that the particles do not settle or settle only relatively more slowly. For example, the dispersion agent may improve the separation of the particles and/or prevent settling and/or clumping of the particles.

In one example, the dispersion agent comprises and/or is Sodium lignosulfonate, 1-Methyl-2-pyrrolidone, Sodium polyacrylate, Butyl acetate, Polyethylene glycol, Xylene, 5-Chloro-2-methyl-4-isothiazolin-3-one, Solvent naphtha (petroleum), Sodium hydroxide, Polyacrylic acid, Naphthalenesulfonic acid, 1-Hydroxyethane-1,1-diphosphonic acid, Formaldehyde, Sodium sulphate, 1-Hexadecanol, 2-Methyl-4-isothiazolin-3-one, 1-Methoxy-2-propanol acetate, 1,2-Propanediol, 1-Methoxy-2-propanol, Sodium Nitrate, Benzotriazole, or a mixture thereof. In one preferred example, the dispersion agent comprises and/or is 1-Methyl-2-pyrrolidone, 1-Methoxy-2-propanol acetate, 1,2-Propanediol, 1-Methoxy-2-propanol, Sodium Nitrate, Benzotriazole, or a mixture thereof.

In one example, the liquid comprises a thickening agent (also known as a rheology modifier), to increase the viscosity of the liquid, in a range from 0 wt. % to 5 wt. %, preferably in a range from wt. % to 3 wt. %, more preferably in a range from 0.2 wt. % to 2 wt. %, by weight of the liquid. In this way, a relatively more homogeneous dispersion of the particles in the dispersion may be achieved and/or a relatively more stable dispersion, for example such that the particles do not settle or settle only relatively more slowly. Suitable rheology modifiers include: polyurethanes, acrylic polymers, latex, styrene/butadiene; polyvinyl alcohol (PVA); clays such as attapulgite which also disperses suspensions, bentonite (both flocculating and non-flocculating), and other montmorillonite clays; cellulosics such as CMC, HMC, HPMC, and others, all are chemically substituted cellulose macromolecules; sulfonates such as sodium or calcium salts; gums such as guar, xanthan, cellulose, locust bean, and acacia; saccharides such as carrageenan, pullulan, konjac, and alginate, sometimes called hydrocolloids; proteins such as casein, collagen and albumin; modified castor oil; and/or organosilicones such as silicone resins, dimethicones, and modified silicones. In one example, the thickening agent comprises and/or is silica (amorphous, fumed), 5-Chloro-2-methyl-4-isothiazolin-3-one, 2-Methyl-4-isothiazolin-3-one, Sodium carboxymethyl cellulose; and/or mixtures thereof.

In one example, the liquid comprises a viscosity regulating agent to regulate the viscosity of the liquid, in a range from 0 wt. % to 5 wt. %, preferably in a range from 0.1 wt. % to 3 wt. %, more preferably in a range from 0.2 wt. % to 2 wt. %, by weight of the liquid. In one example, the viscosity regulating agent comprises and/or is a distillates (petroleum) such as solvent-dewaxed heavy paraffinic, solvent-refined heavy paraffinic, solvent-refined light paraffinic; formaldehyde; 2-Propenoic acid, 2-methyl-, methyl ester, polymer with 2-propenyl 2-methyl-2-propenoate; and/or mixtures thereof.

In one example, the liquid comprises a resinous agent (for example, an adhesive) to improve bonding between the particles and the reinforcement fibres, in a range from 0 wt. % to 5 wt. %, preferably in a range from 0.1 wt. % to 3 wt. %, more preferably in a range from 0.2 wt. % to 2 wt. %, by weight of the liquid. In one example, the resinous agent comprises and/or is one or more of: water-soluble, ammonium salts of polyamic acids such as LaRC TPI (NH4PAA) and copolymer bis-aniline-P/benzophenone tetracarboxylic dianhydride (Bis P-BTDA); HPC E, a type of hydroxypropylcellulose which is a non-ionic, water-soluble cellulose derivative containing an average of 2.5 hydroxypropyl groups per backbone repeat unit and an approximate molecular weight of 60 kg mol⁻¹; Pluronics F-38 and F-108, triblock copolymers with a polypropylene centre block and poly(ethylene oxide) tail blocks containing roughly 80 wt % poly(ethylene oxide) with molecular weights of 4.7 and 14.6 kg mol⁻¹, respectively; Polyamic acids (PAA) prepared from (1) benzophenone tetracarboxylic dianhydride (BTDA) and 4,4′-diaminodiphenyl ether (ODA), (2) BTDA and 4,4′-diaminodiphenyl sulfone (DAS), and/or (3) BTDA and ODA modified with bisaminopropyldisilane, designated as PAA-1, PAA-2 and PAA-3; and/or PEI dissolved in NMP with added Graphene Oxide.

In one example, the liquid comprises a surfactant, in a range from 0 wt. % to 5 wt. %, preferably in a range from 0.1 wt. % to 3 wt. %, more preferably in a range from 0.2 wt. % to 2 wt. %, by weight of the liquid. Suitable surfactants include Cremophors, Hydroxypropyl cellulose, Pluronic, Dowfax, Triton X-100, Ammonium hydroxide, N-methyl-pyrrolidone, TDL-ND2 and mixtures thereof. In one example, the surfactant comprises a nonionic, an anionic, a cationic and/or a Zwitterionic surfactant. Suitable nonionic surfactants include Triton™ X-100 (Polyoxyethylene glycol octylphenol ethers: C8H17-(C6H4)-(O—C2H4)1-25-OH), Nonoxynol-9 (Polyoxyethylene glycol alkylphenol ethers: C9H19-(C6H4)-(O—C2H4)1-25-OH), Polysorbate (Polyoxyethylene glycol sorbitan alkyl esters), Span® (Sorbitan alkyl esters), Poloxamers such as Tergitol™, Antarox® (Block copolymers of polyethylene glycol and polypropylene glycol). Suitable anionic surfactants include PENTEX® 99 (Dioctyl sodium sulfosuccinate (DOSS), PFOS (Perfluorooctanesulfonate), Calsoft® (Linear alkylbenzene sulfonates), Texapon® (Sodium lauryl ether sulfate), Darvan® (Lignosulfonate), sodium is the rate and/or mixtures thereof.

In one example, the liquid comprises LiquiPowder Concentrate (Part Number: L20-C) and/or is LiquiPowder Base (Part Number: L20-B) (available from Tech Line Coatings Inc, CA, USA).

Typically, LiquiPowder (i.e. LiquiPowder Concentrate after 1:2 dilution with distilled water or LiquiPowder Base) is used for powder coating of metals. According to the manufacturer's instructions, powder is mixed into the LiquiPowder, typically in a weight ratio of 52:48, by stirring or shaking LiquiPowder prior to use, adding the powder to the LiquiPowder while continuing to mix slowly and then mixing at high speed using a dispersing blade when all powder has been added until the mixture is uniform and the powder wetted. The mixture is sprayed, for example using a spray gun having a 2 mm or larger nozzle at a pressure of about 60 psi or more, onto the metal to be coated. The coated metal is then dried and the powder cured.

The Safety Data Sheets for LiquiPowder Concentrate and LiquiPowder Base (available from https://techlinecoatings.com/product-info-2/sds/) provide composition information, as reproduced in Table 1:

TABLE 1
Composition information of LiquiPowder Concentrate

| | | LiquiPowder | LiquiPowder |
|---|---|---|---|
| | | Concentrate | Base |
| Component Name | CAS# | wt. % | wt. % |
| 1-Methyl-2- | 872-50-4 | <2% | <0.5% |
| pyrrolidone | | | |
| 1-Methoxy-2- | 108-65-6 | <1% | <0.5% |
| propanol acetate | | | |
| 1,2-Propanediol | 57-55-6 | <1% | <0.5% |
| 1-Methoxy-2- | 107-98-2 | <1% | <0.5% |
| propanol | | | |
| Sodium Nitrate | 7632-00-0 | <1% | <0.5% |
| Benzotriazole | 95-14-7 | <1% | <0.5% |
| Lithium chloride | 7447-41-8 | <0.1% | <0.05% |

Surprisingly, the inventors have identified that dispersion systems for powder coating of metals, such as LiquiPowder, are suitable for preparing the dispersion of the first aspect. However, in contrast to the manufacturer's instructions for LiquiPowder for powder coating of metals, the liquid of the first aspect comprises LiquiPowder at a relatively higher dilution in deionised water (dilutions by weight). Particularly, a dilution of 1:3 to 1:4 is suitable, preferably about 1:3, rather than 1:2 according to the manufacturer's instructions.

Particularly, as described by the inventors, LiquiPowder is a water based non-hazardous dispersion system that allows virtually any particles to be suspended in a slurry. LiquiPowder contains a blend of dispersing and water-thickening agents that promote homogenous dispersion of the particles in the slurry for prolonged periods without settling and helps preventing particle clumping. Resinous ingredients in LiquiPowder provide improved initial bonding between particles and reinforcement fibres, holding the particles firmly on the reinforcement fibres even after the water base has been dried and evaporated. Melting the particles subsequently results in permanent bond with the reinforcement fibres. The basic powder is all that remains after curing so that the full characteristics are effective for bonding. Everything in the liquid (i.e. the water together with the components of the LiquiPowder) is evaporated and thus removed upon melting the particles and only the resin remains.

In one example, the liquid (i.e. all components thereof) has a boiling point lower than the melting point of the particles. In this way, the liquid evaporates and is removed during the melting, thereby eliminating voids due to trapped volatiles and hence reducing porosity. In one example, melting at least some of the redistributed particles comprised in the coating comprises removing, for example by evaporation, the liquid, for example at least 90 wt. %, preferably at least 95 wt. %, more preferably at least 97.5 wt. %, even more preferably at least 99 wt. %, most preferably at least 99.9 wt. % of the liquid, by weight of the liquid.

In one example, the dispersion comprises the particles of the first polymeric composition in a range from 2.5 wt. % to 50 wt. %, preferably in a range from 5 wt. % to 40 wt. %, more preferably in a range from 7.5 wt. % to 35 wt. %, most preferably in a range from 10 wt. % to 30 wt. %, by weight of the dispersion. That is, in contrast to the manufacturer's instructions for LiquiPowder for powder coating of metals, the proportion (i.e. wt. %) of these particles in the liquid is significantly reduced. Furthermore, by controlling the proportion these particles in the liquid, the fibre volume fraction V_{f} is controlled. For example, by reducing the proportion these particles in the liquid, the fibre volume fraction V_{f} is increased, for a given first set of reinforcement fibres.

In one example, the dispersion comprises particles of a filler, for example a nanomaterial such as a 2D material, such as graphene, or a nanoclay, for example in a range from 0.01 wt. % to 25 wt. %, preferably in a range from 0.1 wt. % to 15 wt. %, more preferably in a range from 0.25 wt. % to 10 wt. %, most preferably in a range from 0.5 wt. % to 5 wt. %, by weight of the particles in the dispersion. In this way, mechanical properties of the fibre-reinforced composite may be improved, for example tensile strength, bending, interlaminar shear and/or fire resistance.

The method comprises coating, at least in part, the first set of reinforcement fibres with the dispersion.

In one example, the first set of reinforcement fibres comprises and/or is a roving (also known as a tow, with roving used typically for glass fibres and tow used typically for carbon fibres).

In one example, the first tow comprises and/or is a 1K tow, a 3K tow, a 6K tow, a 12 K tow, a 24K tow or a 50K tow, for example having a weight in a range from 60 g/m²-1200 g/m². Other tows are known.

In one example, the first set of reinforcement fibres comprises non-metal fibres for example glass fibres such as A-glass, E-glass, E-CR-glass, C-glass, D-glass, R-glass, S-glass, S-2-glass and HS-glass; carbon fibres such as aerospace or industrial grades of IM2A, IM2C, IM5, IM6, IM7, IM8, IM9, IM10, AS4, AS4A, AS4C, AS4D, AS7, HM50 and HM63; aramid fibres such as Kevlar®, Nomex® and Technora®; Ultra-High Molecular Weight Polyethylene (UHMwPE) fibres such as Dyneema®; basalt fibres such as Basfiber® or Wiking® Super B; and/or mixtures thereof.

In one example, the first set of reinforcement fibres have a diameter in a range from 2 μm to 100 μm, preferably in a range from 4 μm to 50 μm, more preferably in a range from 5 μm to 20 μm, most preferably in a range from 6 μm to 10 μm, for example 6 μm, 7 μm, 8 μm, 9 μm or 10 μm. Typically, suitable carbon fibres have a diameter in a range from 7 μm to 10 μm and suitable glass fibres have a diameter in a range from 4 μm to 20 μm.

In one example, the first set of reinforcement fibres comprises and/or unidirectional and/or continuous fibres, for example having a length of at least 10 m, at least 100 m, at least 1 km, at least 10 km. In this way, relatively larger fibre reinforced composite materials may be provided. In one example, coating, at least in part, the first set of reinforcement fibres with the dispersion comprises immersing the first set of reinforcement fibres in the dispersion, for example in a bath thereof, preferably while tensioning the first set of reinforcement fibres. In this way, a relatively more uniform coating is achieved. In one example, coating, at least in part, the first set of reinforcement fibres with the dispersion comprises contacting the first set of reinforcement fibres with the dispersion, for example by spraying therewith and/or immersing therein.

In one example, coating, at least in part, the first set of reinforcement fibres with the dispersion comprises coating, at least in part, the first set of reinforcement fibres with the dispersion at a temperature in a range from 5° C. to 50° C., preferably in a range from 10° C. to 40° C., more preferably in a range from 15° C. to 30° C., for example 20° C. or 25° C., for example room temperature.

In one example, coating, at least in part, the first set of reinforcement fibres with the dispersion comprises coating, at least in part, the first set of reinforcement fibres with the dispersion at a speed in a range from 0.01 ms⁻¹ to 2.0 or 10 ms⁻¹, preferably in a range from 0.05 ms⁻¹ to 1.0 ms⁻¹, more preferably in a range from 0.1 ms⁻¹ to 0.5 ms⁻¹.

In one example, the method comprises spooling the first set of reinforcement fibres from a first spool, for example before coating, at least in part, the first set of reinforcement fibres.

In one example, the method comprises repositioning the first set of reinforcement fibres before and/or after coating, at least in part, a first set of reinforcement fibres with the dispersion. In one example, the method comprises spreading the first set of reinforcement fibres, for example before coating, at least in part, the first set of reinforcement fibres.

The method comprises redistributing the particles of the first polymeric composition comprised in the coating. That is, the particles in the coating on the first set of reinforcement fibres are redistributed, so as to improve uniform distribution thereof. In this way,

In one example, redistributing the particles of the first polymeric composition comprised in the coating comprises rearranging (for example spreading laterally, mutually separating) the coated first set of reinforcement fibres, for example by passing the coated first set of reinforcement fibres through (i.e. over and/or or under) a first set of rollers including a first roller (i.e. a fibre spreading assembly), for example while tensioning the coated first set of reinforcement fibres. In this way, the coating, and hence the particles, is redistributed while a lateral spacing of the first set of reinforcement fibres is improved and/or a thickness of the coated first set of reinforcement fibres may be controlled, thereby reducing areal weight variation and/or reducing thickness variation, respectively. As described below detail, bypassing the coated fibres over and/or under rollers, the forces applied by the rollers on the coated fibres spread the fibres laterally and/or cause the particles to impregnate between the fibres. By impregnating between the fibres, the particles further spread the fibres laterally, acting as spaces and then by promoting further impregnation of particles between the fibres. In one example, the first set of rollers comprises one or more fixed rollers and one or more moveable rollers, for example disposed alternately with and/or between the one or more fixed rollers. The fibre spreader assembly provides control over the spread of fibre (prepreg thickness) and helps impregnate the fibres with the particles. The idea here is to pass the fibre tow (i.e. the first set of reinforcement fibres) above and below a series of, for example ceramic or stainless steel, rollers in order to push the particles inside or into the fibre tow. The forces exerted on the fibre tow by the rollers helps the dispersion to diffuse or mutually separate the fibre filaments and therefore impregnate the fibre tow. These forces also help individual reinforcement fibres to slide on each other, spreading the fibre tow and reducing the thickness of the fibre tow. The fibre tow is also spread further by the particles in the dispersion, which act as spacers between the individual reinforcement fibres when the dispersion penetrates the fibre tow.

In one example, redistributing the particles of the first polymeric composition comprised in the coating comprises vibrating (or oscillating) the coated first set of reinforcement fibres. In one example, vibrating the coated first set of reinforcement fibres comprises vibrating the coated first set of reinforcement fibres transversely i.e. transversely to the axis thereof, for example using a vibrating (for example, ultrasonically) roller over or under which the first set of reinforcement fibres is passed. In one example, vibrating the coated first set of reinforcement fibres comprises vibrating the coated first set of reinforcement fibres axially, for example using a rocking arm for periodically varying or cycling tensioning of the coated first set of reinforcement fibres, for example by applying a reciprocating motion on the coated first set of reinforcement fibres axially. In one example, periodically varying or cycling tensioning of the coated first set of reinforcement fibres comprises alternately tensioning and relaxing, for example removing tension, the coated first set of reinforcement fibres, for example while continuously conveying the coated first set of fibres, for example by laying or winding. For example, spreading of the first set of reinforcement fibres and/or impregnation of the dispersion into the first set of reinforcement fibres is further enhanced by applying a reciprocating motion on the coated first set of reinforcement fibres, held for example between a set of rollers. Each reciprocating motion of the coated first set of reinforcement fibres may be referred to as a tension-cycle. Increasing the number of tension-cycles enhances spreading and/or impregnation, with about six tension-cycles resulting in equilibrium in the degree of fibre spreading. Releasing the tension in the fibre tow and re-applying the tension-cycle may additionally enhance the degree of lateral spreading of the reinforcement fibres. In one example, the fibre spreader assembly employs an angular reciprocating mechanism to create a vibration in a set of rollers. This fibre spreader assembly employs the operating principle described above for creating a tension-cycle, improved by automating the movement. The fibre spreader assembly not only provides the reciprocating motion, but by spooling the fibre tow from spool faster than a winding unit (i.e. the means for laying), it maintains the fibre tow within the spreading unit in low tension and/or tension-free state. This results in greater fibre spreading. Two factors in the fibre spreader assembly can be controlled; the frequency and the amplitude of the motion. The frequency of the tension-cycle can be adjusted via controlling a speed of a DC motor, for example. The motion amplitude of rollers can be changed with using eccentric cams with different off-sets or adjusting the level of the eccentric cam.

In one example, redistributing the particles of the first polymeric composition comprised in the coating is at a temperature below a melting point of the first thermoplastic, for example at a temperature in a range from 5° C. to 50° C., preferably in a range from 10° C. to 40° C., more preferably in a range from 15° C. to 30° C., for example 20° C. or 25° C., for example room temperature.

In one example, the method comprises drying the coated first set of reinforcement fibres, for example after redistributing the particles and before melting at least some of the redistributed particles. In this way, the liquid evaporates and is removed during the melting, thereby eliminating voids due to trapped volatiles and hence reducing porosity. In one example, drying the coated first set of reinforcement fibres comprises removing, for example by evaporation, the liquid, for example at least 90 wt. %, preferably at least 95 wt. %, more preferably at least 97.5 wt. %, even more preferably at least 99 wt. %, most preferably at least 99.9 wt. % of the liquid, by weight of the liquid.

In one example, the method comprises laying the coated first set of reinforcement fibres, for example after redistributing the particles and before melting at least some of the redistributed particles, for example thereby providing a sheet or a laminate. In one example, laying the coated first set of reinforcement fibres comprises winding the coated first set of reinforcement fibres on a drum, for example steering helically around the drum, preferably wherein a pitch of the helix corresponds with (i.e. is the same as) width of the coated first set of reinforcement fibres, thereby forming a tube. In one example, winding the coated first set of reinforcement fibres on the drum comprises spooling the first set of reinforcement fibres from a first spool, immersing the spooled first set of reinforcement fibres in the dispersion, passing the coated first set of reinforcement fibres through a first set of rollers, thereby redistributing the particles comprising the coating, vibrating the coated first set of reinforcement fibres axially using a rocking arm and winding the coated first set of reinforcement fibres helically around the drum. In one example, laying the coated first set of reinforcement fibres comprises laying a plurality of layers thereof. In this way, a laminate may be provided.

The method comprises melting at least some of the redistributed particles of the first polymeric composition comprised in the coating, thereby providing the composite material.

In one example, melting at least some of the redistributed particles of the first polymeric composition comprised in the coating comprises melting the coated first set of reinforcement fibres while laying the coated first set of reinforcement fibres, for example using a radiant heater.

In one example, melting at least some of the redistributed particles of the first polymeric composition comprised in the coating comprises melting the coated first set of reinforcement fibres after laying the coated first set of reinforcement fibres, for example in an oven.

In one example, the method comprises tensioning the first set of reinforcement fibres while melting at least some of the redistributed particles of the first polymeric composition comprised in the coating. In this way, the uniform distribution of the melted, redistributive particles is maintained.

In one example, the method comprises laminating the fibre reinforced composite material, after melting. For example, the laminating may be performed after prepreg production, in which the impregnated fibre tow is wound on a drum coupled with actuation of the winding (left to right or right to left) to form unidirectional composite prepreg on the drum. The drum is then subsequently heated above the melting temperature of the polymer for permanent bonding between the polymer and the fibres. The prepreg sheet is then cut from the drum and further cut into the desired pieces (sizes) in single ply. Plies are stacked and heat pressed to form a laminate.

In one example, the method comprises and/or is a continuous method, wherein the coating, the redistributing and the melting are performed continuously on successive length of the first set of reinforcement fibres, for example while continuously spooling the uncoated first set of reinforcement fibres from a spool and while continuously laying the coated first set of fibres, for example by winding on a drum.

### Apparatus

The second aspect provides an apparatus for providing a fibre-reinforced composite material, the apparatus comprising:
means for coating, at least in part, a first set of reinforcement fibres with a dispersion comprising particles of a first polymeric composition comprising a first thermoplastic in a liquid comprising water;
means for redistributing the particles of the first polymeric composition comprised in the coating; and
means for melting at least some of the redistributed particles of the first polymeric composition comprised in the coating, thereby providing the composite material.

The fibre reinforced composite material, the coating, the first set of reinforcement fibres, the dispersion, the particles, the first polymer composition, the first thermoplastic, the liquid, the redistribution and/or the melting is described with respect to the first aspect.

In one example, the apparatus comprises a spooling device, for spooling the first set of reinforcement fibres from the first spool.

In one example, the means for coating comprises a sprayer for spraying the first set of reinforcement fibres with the dispersion. In one example, the means for coating comprises a bath, arranged to receive the dispersion therein, and means for immersing the first set of reinforcement fibres in the dispersion.

In one example, the means for redistributing the particles of the first polymeric composition comprised in the coating comprises a first set of rollers including a first roller for passing the coated first set of reinforcement fibres therethrough. In one example, the first roller is a drive roller, for tensioning the coated first set of reinforcement fibres. In one example, the first set of rollers includes a second roller, wherein the second roller is an idler roller. In one example, the apparatus comprises means for vibrating the first set of reinforcement fibres. In one example, the means for vibrating the first set of reinforcement fibres comprises a vibrating roller, for example included in the first set of rollers, configured to vibrate actually and/or transversely to the axis thereof. In one example, the means for vibrating the first set of reinforcement fibres comprises a rocking arm. In one example, the rocking arm comprises a second set of rollers including a first roller, for example an idler roller. In one example, the rocking arm comprises an actuator, configured to oscillate the rocking arm, for example an eccentric cam and a restoring spring. In one example, the rocking arm comprises a second set of rollers including a first roller. In one example, the apparatus comprises drying means arranged to dry the coated first set of reinforcement fibres.

In one example, the apparatus comprises means for laying the coated first set of reinforcement fibres. In one example, the means for laying comprises a drum, for example a drive drum, and optionally, means for steering the coated first set of reinforcement fibres on the drum. In one example, the means for steering comprises an actuator arranged to axially displace the drum synchronously with rotation thereof, so as to lay the coated first set of reinforcement fibres helically on the drum. In one example, the means for steering comprises a moveable or steering roller.

In one example, the apparatus comprises a controller configured to control a speed of conveying of the first set of reinforcement fibres.

In one example, the means for melting comprises a heater.

### Fibre-Reinforced Composite Material

A third aspect provides a fibre-reinforced composite material comprising a first set of reinforcement fibres, surrounded by a first polymeric composition comprising a first thermoplastic polymer; wherein a volume fraction of the first set of fibres is in a range from 50% to 70% by volume of the composite material; optionally wherein the polymeric composition comprises a filler, for example a nanomaterial such as a 2D material or a nanoclay, in a range from 1 wt. % to 10 wt. % by weight of the composite material.

The fibre reinforced composite material, the first set of reinforcement fibres, the first polymeric composition, the first thermoplastic and/or the filler maybe as described with respect to the first aspect.

In one example, the fibre reinforced composite material comprises and/or is a pre-preg, as described with respect to the first aspect.

In one example, the fibre reinforced composite material is a laminate, as described with respect to the first aspect. In one example, the fibre reinforced composite material has a porosity (i.e. a void volume) in a range from 0.001% to 5%, preferably in a range from 0.01% to 1%, more preferably in the range from 0.01% to 0.1%, by volume of the fibre reinforced composite material. PAEK PSD graph requested, particle size previously advised to be D50: 10 microns.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 schematically depicts a method according to an exemplary embodiment;

FIG. 2A schematically depicts a side elevation view of an apparatus according to an exemplary embodiment; FIG. 2B schematically depicts the apparatus, in more detail; FIG. 2C schematically depicts a side elevation view of an operating principle of the apparatus; FIG. 2D schematically depicts a side elevation view of the apparatus, in more detail; FIG. 2E schematically depicts a side elevation view of the apparatus, in use; and FIG. 2F schematically depicts a plan view of alternatives for the apparatus;

FIG. 3A is a photograph of side elevation view an apparatus according to an exemplary embodiment; FIG. 3B is a photograph of a front elevation view of the apparatus; and FIG. 3C is a photograph of a front elevation of the apparatus, in more detail;

FIG. 4A is a photograph of a glass fibre-reinforced composite material according to exemplary embodiment; and FIG. 4B is a photograph of the laminated fibre-reinforced composite material;

FIG. 5A is a photograph of a carbon fibre-reinforced composite material according to exemplary embodiment; and FIG. 5B is a photograph of the laminated fibre-reinforced composite material;

FIG. 6 schematically depicts a method of laminating a fibre-reinforced composite material according to exemplary embodiment;

FIG. 7A is a micrograph of a transverse cross-section of a fibre-reinforced composite material according to an exemplary embodiment; and FIG. 7B is a micrograph of a transverse cross-section of a conventional fibre-reinforced composite material;

FIG. 8A is a micrograph of a transverse cross-section of a fibre-reinforced composite material according to an exemplary embodiment, having a V_{f}=70%; FIG. 8B is a micrograph of a transverse cross-section of a fibre-reinforced composite material according to an exemplary embodiment, having a V_{f}=47%; and FIG. 8C is a micrograph of a transverse cross-section of a fibre-reinforced composite material according to an exemplary embodiment, having a V_{f}=31%;

FIG. 9A is a graph of tensile strength of three GF/PAEK fibre-reinforced composite materials according to exemplary embodiments, having V_{f}=70%; V_{f}=46%; and V_{f}=38%, respectively;

FIG. 9B is a graph of failure strain of the three GF/PAEK fibre-reinforced composite materials of FIG. 9A; and FIG. 9C is a graph of tensile modulus 0° of the three GF/PAEK fibre-reinforced composite materials of FIG. 9A;

FIG. 10A a graph of tensile strength of two conventional S2/PEEK fibre-reinforced composite materials compared with a S2/PAEK fibre-reinforced composite material according to an exemplary embodiment; and FIG. 10B is a graph of tensile modulus 0° of the two conventional S2/PEEK fibre-reinforced composite materials compared with a S2/PAEK fibre-reinforced composite material according to the exemplary embodiment of FIG. 10A;

FIG. 11 is a photograph of five fibre-reinforced composite materials according to exemplary embodiments comprising graphene at A: 0.0 wt. %; B: 0.5 wt. %; C: 1.0 wt. %; D: 2.5 wt. %; and E: 5.0 wt. %;

FIG. 12 is a graph of tensile strength of a fibre reinforced composite material according to an exemplary embodiment as a function of temperature; and

FIG. 13A is a particle size distribution for particles of a first polymeric composition for a method according to an exemplary embodiment; and FIG. 13B is a particle size distribution for particles of a first polymeric composition for a method according to an exemplary embodiment.

### DETAILED DESCRIPTION OF THE DRAWINGS

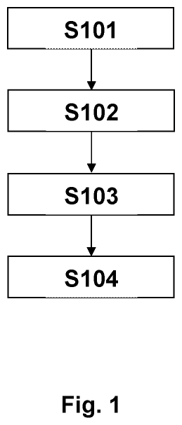

FIG. 1 schematically depicts a method according to an exemplary embodiment.

At S101, the method comprises dispersing particles of a first polymeric composition comprising a first thermoplastic in a liquid comprising water, thereby forming a dispersion.

At S102, the method comprises coating, at least in part, a first set of reinforcement fibres with the dispersion.

At S103, the method comprises redistributing the particles of the first polymeric composition comprised in the coating.

At S104, the method comprises melting at least some of the redistributed particles of the first polymeric composition comprised in the coating, thereby providing the composite material.

The method may include any of the steps described with respect to the first aspect.

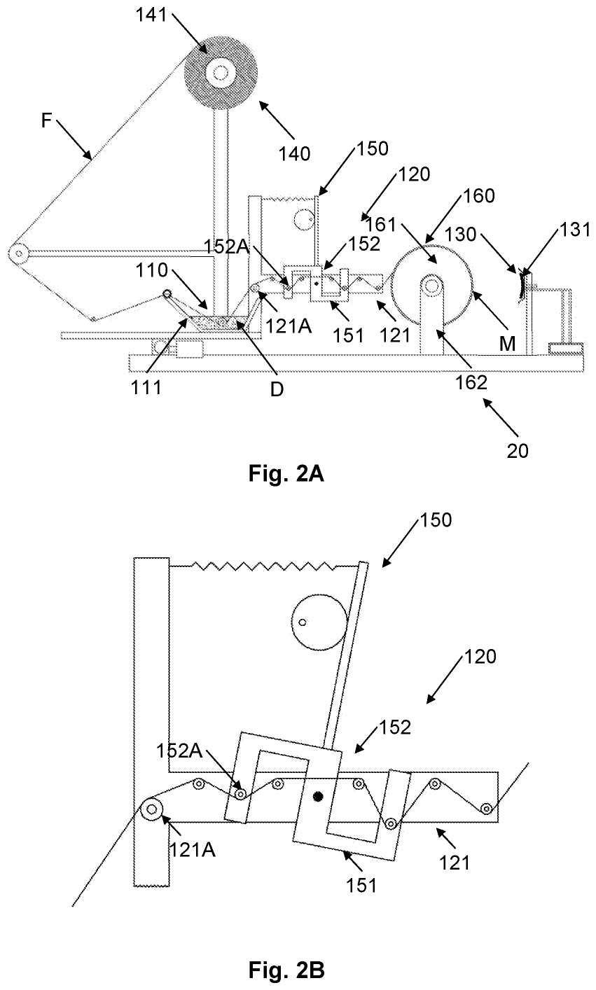

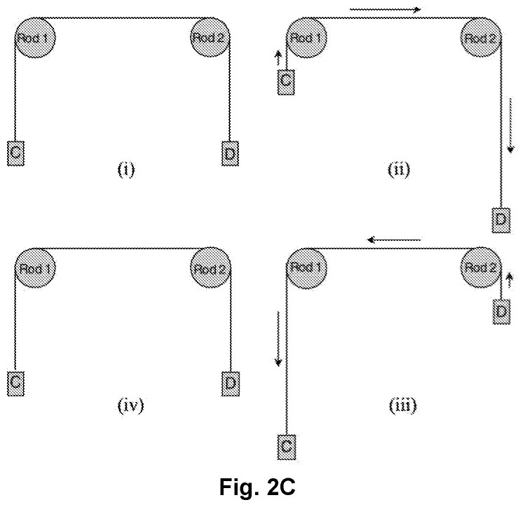

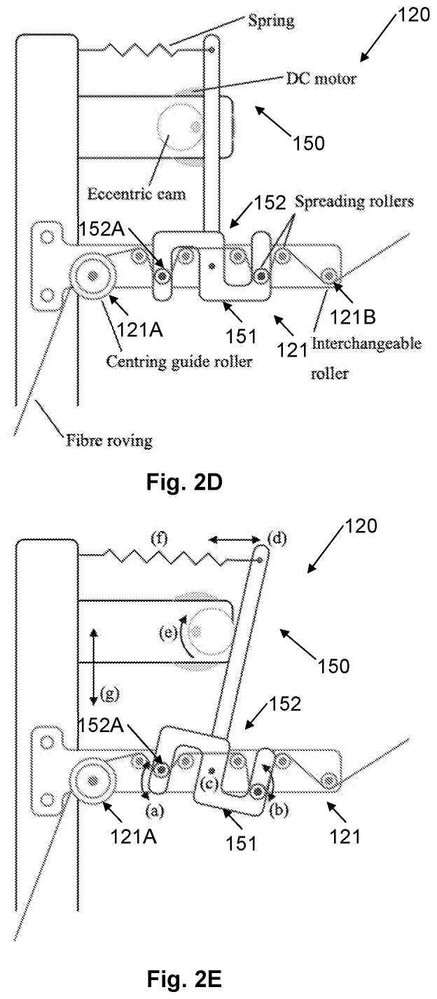

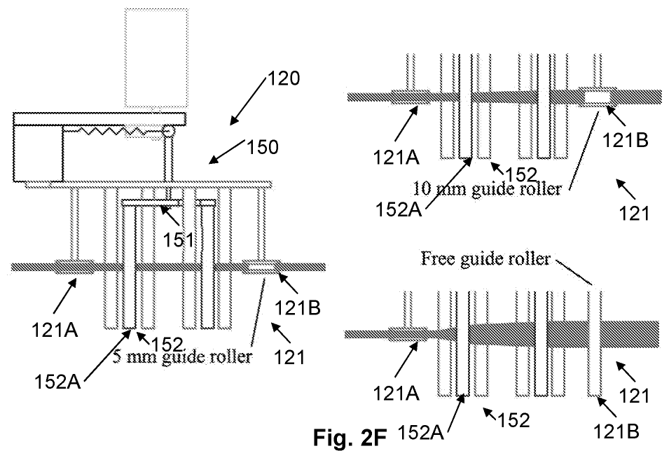

FIG. 2A schematically depicts a side elevation view of an apparatus 20 according to an exemplary embodiment; FIG. 2B schematically depicts a side elevation view of the apparatus in more detail.

The second aspect provides an apparatus 20 for providing a fibre-reinforced composite material M, the apparatus 20 comprising:
means for coating 110, at least in part, a first set of reinforcement fibres F with a dispersion D comprising particles of a first polymeric composition comprising a first thermoplastic in a liquid comprising water;
means for redistributing 120 the particles of the first polymeric composition comprised in the coating; and
means for melting 130 at least some of the redistributed particles of the first polymeric composition comprised in the coating, thereby providing the composite material.

In this example, the apparatus 20 comprises a spooling device 140, for spooling the first set of reinforcement fibres F from the first spool 141.

In this example, the means for coating 110 comprises a bath 111, arranged to receive the dispersion D therein, and means for immersing the first set of reinforcement fibres F in the dispersion D.

In this example, the means for redistributing 120 the particles of the first polymeric composition comprised in the coating comprises a first set of rollers 121 including a first roller 121A (i.e. a fixed roller) for passing the coated first set of reinforcement fibres F therethrough. In this example, the first roller 121A is a drive roller, for tensioning the coated first set of reinforcement fibres F. In this example, the first set of rollers 121 includes a second roller, wherein the second roller is an idler roller. In this example, the apparatus 20 comprises means for vibrating 150 the first set of reinforcement fibres F. In this example, the means for vibrating 150 the first set of reinforcement fibres F comprises a vibrating roller, for example included in the first set of rollers 121, configured to vibrate actually and/or transversely to the axis thereof. In this example, the means for vibrating 150 the first set of reinforcement fibres F comprises a rocking arm 151. In this example, the rocking arm 151 comprises a second set of rollers 152 including a first roller 152A (i.e. a moveable roller), for example an idler roller. In this example, the rocking arm 151 comprises an actuator, configured to oscillate the rocking arm 151. In this example, the first set of rollers 121 comprises one or more fixed rollers and one or more moveable rollers (i.e. the second set of rollers 152), disposed between the one or more fixed rollers.

In this example, the apparatus 20 comprises means for laying 160 the coated first set of reinforcement fibres F. In this example, the means for laying 160 comprises a drum 161, for example a drive drum and means for steering 162 the coated first set of reinforcement fibres F on the drum. In this example, the means for steering 162 comprises an actuator arranged to axially displace the drum 161 synchronously with rotation thereof, so as to lay the coated first set of reinforcement fibres F helically on the drum.

In this example, the apparatus 20 comprises a controller configured to control a speed of conveying of the first set of reinforcement fibres F.

In this example, the means for melting 130 comprises a heater 131.

FIG. 2C schematically depicts a side elevation view of an operating principle of the apparatus 20.

While soaked in the dispersion D, the first set of reinforcement fibres F exits the bath 111 onto the fibre spreader system (i.e. the means for redistributing 120). A spreading mechanism was designed based on a direct contact method (mechanical method); use of spreading pins in which the fibre tow (i.e. the first set of reinforcement fibres F) is passed through a series of rollers to obtain a flat array of separate fibres. The fibre spreader assembly provides control over the spread of fibre (prepreg thickness) and helps impregnate the fibres with the particles. The idea here is to pass the fibre tow above and below a series of, for example ceramic or stainless steel, rollers (i.e. the first set of rollers 121) in order to push the particles inside or into the fibre tow. The forces exerted on the fibre tow by the rollers helps the dispersion D to diffuse or mutually separate the fibre filaments and therefore impregnate the fibre tow. These forces also help individual reinforcement fibres to slide on each other, spreading the fibre tow and reducing the thickness of the fibre tow. The fibre tow is also spread further by the particles in the dispersion D, which act as spacers between the individual reinforcement fibres when the dispersion D penetrates the fibre tow.

Spreading of the first set of reinforcement fibres F and/or impregnation of the dispersion D into the first set of reinforcement fibres F is further enhanced by applying a reciprocating motion on the fibre tow, held between a set of rollers. Each reciprocating motion, from step (i) to step (iv), of the fibre tow may be referred to as a tension-cycle, as shown in FIG. 2C. Increasing the number of tension-cycles enhances spreading and/or impregnation, with about six tension-cycles resulting in equilibrium in the degree of fibre spreading. Releasing the tension in the fibre tow and re-applying the tension-cycle may additionally enhance the degree of lateral spreading of the reinforcement fibres.

FIG. 2D schematically depicts a side elevation view of the apparatus 20, in more detail; and FIG. 2E schematically depicts a side elevation view of the apparatus 20, in use.

The design of the novel fibre spreader device (i.e. the means for redistributing 120) is based on the operating principle described above. The fibre spreader employs an angular reciprocating mechanism to create a vibration in a set of rollers. This device employs the operating principle described above for creating a tension-cycle, improved by automating the movement. The spreading device not only provides the reciprocating motion, but by spooling the fibre tow from spool faster than the winding unit (i.e. the means for laying 160), it maintains the fibre tow within the spreading unit in low tension and/or tension-free state. This results in greater fibre spreading. The fibre spreader includes three different parts. The first two parts (pink P and blue B) are comprised of series of DP rollers. The pink P part is static and is bolted to an aluminium profile, which is installed on the linear actuator part as discussed before. The blue part B is dynamic and is connected to the pink part P via a shafted bearing. The shaft is extended to the other end of the bearing and is connected to a spring-loaded arm. The arm is in contact with and follows, due to the spring (e), the third part of the fibre spreader (green G), which is an eccentric cam connected to a DC motor. The amplitude of the oscillation may be adjusted by moving (g) where the cam contacts the arm.

Briefly, rotation of the eccentric cam (e) causes the arm (d) to oscillate about the bearing (c). In turn, this causes oscillation of the rollers (a) and (b).

As illustrated in, the process begins when the impregnated fibre tow glides over the centring roller. As mentioned before, all the rollers except (a) and (b) are fixed on the static part of the fibre spreader assembly. Roller (a) and (b) however are mounted on a separate dynamic plate. The sequence begins when fibre tow is passed over the first roller and goes below roller (a), coming up and over two consecutive rollers, passes below roller (b) and goes over and under two more rollers. The spreading process begins when the eccentric cam (e) mounted on a DC motor starts rotating. By the means of this rotation, rod (d) starts a reciprocating motion as shown. Rod (d) is connected to the dynamic plate, which accommodates roller (a) and (b) and because of this, roller (a) and (b) start the reciprocating motion around the pivot point (c). The arm (d) and therefore the dynamic plate is restrained via spring (f). This helps arm (d) and eccentric cam (e) to always stay in contact and the process continues after each motion frequency. The reciprocating motion of roller (a) and (b) will generate the tension-cycle needed and causes the fibre tow to spread laterally on the two rollers between roller (a) and (b). Each motion frequency therefore resembles one tension-cycle described above.

Two factors in the fibre spreader assembly can be controlled; the frequency and the amplitude of the motion. The frequency of the tension-cycle can be adjusted via controlling the speed of the DC motor. The motion amplitude of roller (a) and (b) can be changed with using eccentric cams with different off-sets or adjusting the level (g) of the eccentric cam. For instance, lower levels (g) will result in higher amplitudes of roller (a) and (b).

Besides spreading the fibre tow and adjusting the thickness of the prepreg, the fibre spreading assembly is also responsible for effective PAEK powder impregnation. It is also evident that the fibre tow will spread further when polymer particles are diffused into the fibre tow and act as spacers. It is therefore believed the amount of fibre spread of dry bundle and wet bundle would be different.

FIG. 2F schematically depicts a plan view of alternatives for the apparatus 20.

The fibre spreader includes a number of DP ceramic rollers. The pink static part houses 6 rollers. The first guide is a rotating roller same as the one implemented inside the resin bath. This is a flat groove with a depth of 4 mm and width of 5 mm. This ceramic guide roller helps centring the impregnated fibre tow for the spreading stage. The static part has 4 more 10 mm diameter DP finish ceramic rollers further down the line for impregnation and fibre spread. At the end of the process is an interchangeable roller 121B that can be adjusted according to the spreading needs. Three options where envisioned: 5 mm width roller, 10 mm width roller and free roller. These guide setting options can be seen in FIG. 2F.

The blue dynamic part also accommodates two 10 mm diameter DP ceramic rollers that are responsible for creating the spreading tension-cycle mechanism. All 10 mm diameter rollers can be adjusted to be rotating or non-rotating.

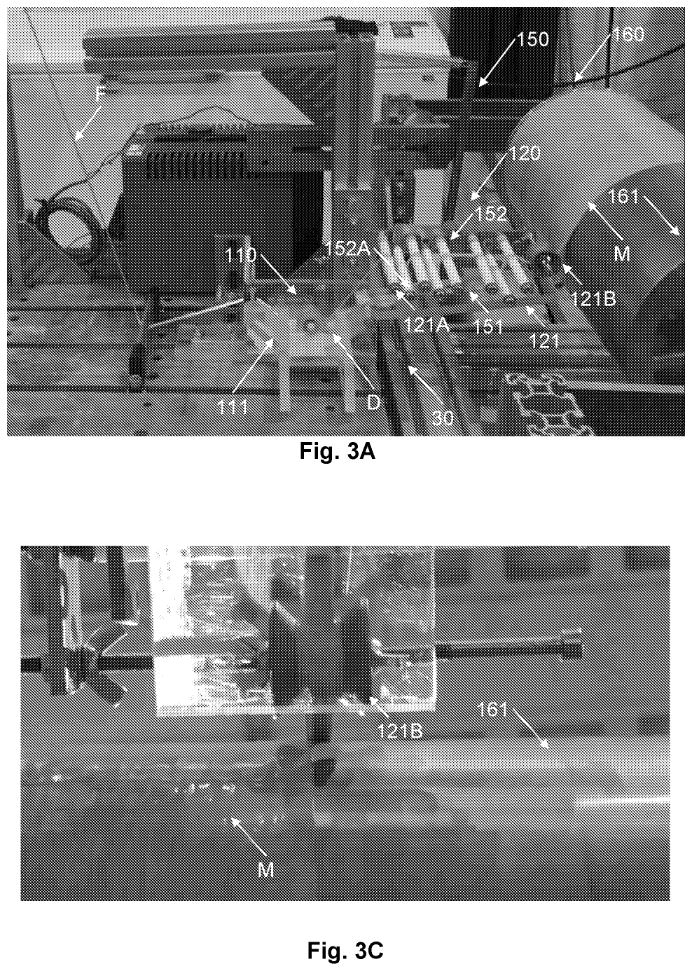

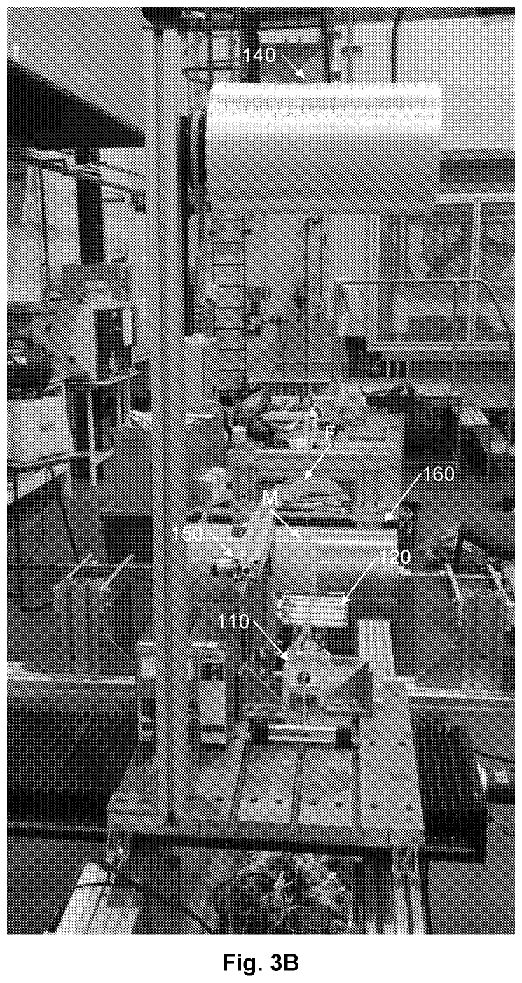

FIG. 3A is a photograph of side elevation view an apparatus 30 according to an exemplary embodiment; FIG. 3B is a photograph of a front elevation view of the apparatus 30; and FIG. 3C is a photograph of a front elevation of the apparatus 30, in more detail.

The apparatus 30 is generally as described with respect to the apparatus 20, like reference signs indicate like features and description of which is not repeated for brevity.

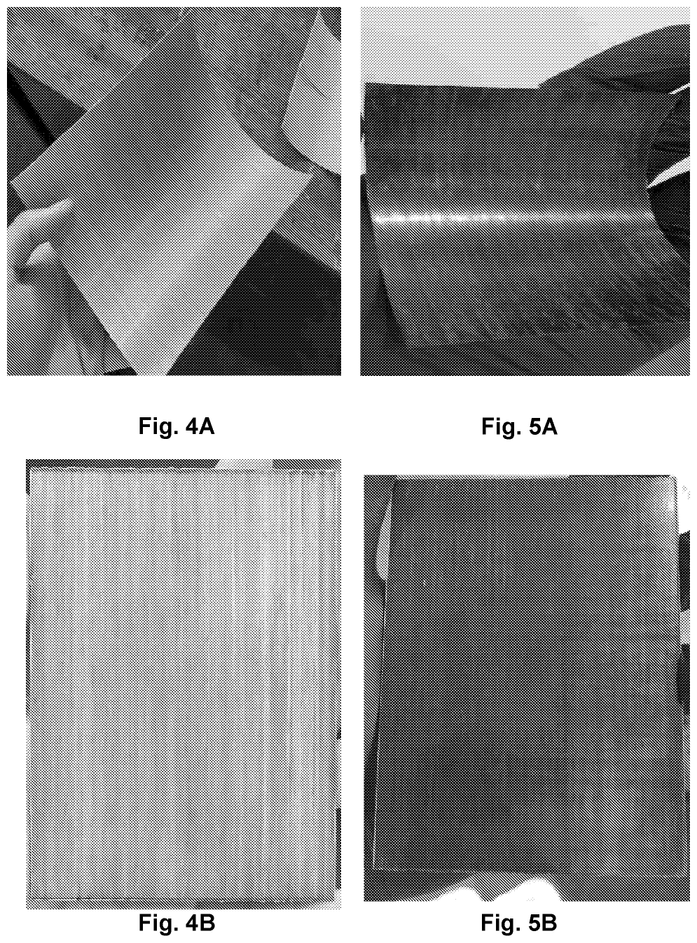

FIG. 4A is a photograph of a fibre-reinforced composite material according to exemplary embodiment; and FIG. 4B is a photograph of the laminated fibre-reinforced composite material.

S2-glass fibre roving was supplied by AGY LLC. (USA). S2-glass fibre is a registered trademark of AGY. The grade of the S2-glass fibre roving used was 933-AA-750. The 933 version is designed for use in aerospace and defence applications. This grade consists of numerous G filament (9 microns) continuous glass strands. The strands are without mechanical twist and are treated with a thermally stable inorganic sizing suitable for high temperature matrices such as PAEKs. The 933 sizing however has poor broken filament resistance. The 933-AA-750 has a linear density of 675 g/1000 m (TEX), with 4200 filaments bundled together approximately.

### Manufacturing Process

### S2-Glass Fibre Tow

S2-glass is the high-end class of glass fibres and can offer up to 85% more tensile strength, while impregnated with resin, than conventional glass fibres. S2-glass fibre offers enhanced weight performance and provides better cost effective performance compared to aramid and carbon fibre. S2-glass has higher level of silica compared to standard glass fibres, which offers higher tensile and compressive strength, better toughness, and high temperature and impact resistance.

S2-glass fibre roving was supplied by AGY LLC. (USA). S2-glass fibre is a registered trademark of AGY, the sole supplier of S2 glass. The grade of the S2-glass fibre roving used was 933-AA-750. The 933 version is designed for use in aerospace and defence applications. This grade consists of numerous G filament (9 microns) continuous glass strands. The strands are without mechanical twist and are treated with a thermally stable inorganic sizing suitable for high temperature matrices such as PAEKs. 933 sizing however has poor broken filament resistance. 933-AA-750 has a linear density of 675 g/1000 m (TEX) and would approximately have 4200 filaments bundled together. Table below shows the technical data sheet of the product.

| Properties | Description or value |
|---|---|
| Fibre properties | |
| Tensile strength (MPa) | 4890 |
| Tensile modulus (GPa) | 89 |
| Strain (%) | 5.7 |
| Density (g/cm³) | 2.47 |
| Filament diameter (μm) | 9 (G) |
| Roving properties | |
| Yield (g/1000 m) | 675 |
| End count | 10 |
| Number of filaments | 4150-4200 |
| Sizing type/Amount (%) | 933/0.23 |
| Twist | Never twisted |

### Polyaryl Ether Ketone (PAEK)

AE 250 PAEK (also known as engineered PAEK) is one of the most recent resin systems developed by Victrex plc. (UK). It is a PEEK based copolymer with much lower Tₘ of 305° C. compared to PEK and T_{g} of 149° C. It can maintain mechanical, physical and chemical properties typically to PEK, PEEK or PEKK. Properties are shown in table below.

| | | Tensile | Tensile | Tensile | Flexural | Flexural |
|---|---|---|---|---|---|---|
| Supplier/ | Chemical | strength | modulus | elongation | strength | modulus |
| Grade | structure | (MPa) | (GPa) | (%) | (MPa) | (GPa) |
| Victrex | PAEK | 90 | 3.5 | 15 | 150 | 3.3 |
| AE 250 | | | | | | |

| | | Glass | Melt | | |
|---|---|---|---|---|---|
| Supplier/ | Melting | transition | viscosity | Density | Particle |
| Grade | point (° C.) | (° C.) | (Pa · s) | (g/cm³) | size (μm) |
| Victrex | 305 | 149 | | 1.28 | (D₅₀) < 10 |
| AE 250 | | | | | |

The lower Tₘ of AE 250 means lower processing temperature of 40 to 60° C., permitting composite parts to be manufactured cheaper and faster with added perks of implementing out of autoclave processing, fast automated lay-up, injection over-moulding and hot stamping, thus eliminating the high number use of expensive autoclaves and factories in which house them. The novel AE 250 is 25-30% semi-crystalline when press consolidated with a cooling rate of 5-10° C./min. The lower melting temperature of AE 250 resin widens the processing window whilst still allowing fully crystalline morphology to develop through the cooling phase. A major advantage of AE 250 is that it could be processed with relatively low pressures, opening gates to the production of high-quality parts utilising out of autoclave processing.

AE 250 is later found to be the most suitable resin system for manufacturing thermoplastic prepreg and is chosen as the main polymer for this research.

### Liquid Carrier

Due to the low surface energy of PAEKs, they are normally not very well dispersed in water, if at all. Water alone cannot fully wet out the PAEK powder and this therefore urges the need for a dispersing agent in order to improve the separation of the particles and to prevent their settling or agglomeration in the slurry.

For this purpose, a liquid carrier from Tech Line Coatings Inc. (USA) with a tradename of LiquiPowder (L2O) was used.

L2O is a water based non-hazardous dispersion system that virtually allows any powder to be suspended in a slurry. L2O contains a blend of dispersing and water-thickening agents that promote homogenous suspension of PAEK particles in the slurry for prolonged periods without settling and helps preventing particle clumping. Resinous ingredients in L2O provide great initial bond between PAEK particles and glass fibre filaments, holding the particles firm on the fibres even after the water base is dried and evaporated. Heat melting the PAEK subsequently results in permanent bond on the reinforcing fibre. The basic powder is all that remains after curing so in effect the full characteristics are in effect for bonding. Everything in the liquid carrier leaves the composite upon melting the PAEK and only the actual resin remains.

### Graphene

Graphene in nanoscale powder was supplied by Versarien plc. (UK) under the trademark of Nanene. Nanene is a high quality, low defect, few-layer and high carbon purity graphene. It has a 2D flake like structure with high lateral dimension, which can create large interfaces within the composite matrix. Below Table demonstrates the properties of Nanene.

| Property | Description or value |
|---|---|
| Layers ≤5, ≤10, >10 (%) | 60, 90, 10 |
| Apparent thickness (nm) | <3.5/10 layers |
| Lateral dimension (μm) | <10 |
| Bulk density (g/cm³) | 0.1857 |
| Surface area (m²/g) | 45 |

### Nanoclay

Montmorillonite nanoclay stock number NS6130-09-902 was received as powder from Nanoshel LLC. (USA) with specification as seen in Table below.

| Property | Description or value |
|---|---|
| Average particle size (μm) | ~1 |
| Bulk density (g/cm³) | 0.7609 |
| Density (g/cm³) | 2.6 |
| Surface area (m²/cm³) | 0.09-1.8 |

### Slurry Preparation

PAEK powder is weighted and added to weighted L2O for mixture. Ratios tested were 10% PAEK to 90% L2O by weight, 20% PAEK to 80% L2O by weight and 30% PAEK to 70% L2O. For instance, 20 grams of PAEK powder was added to 180 grams of L2O to produce 10%/90% ratio slurry. In case of adding nanomaterial, nanomaterial was added 0.5, 1, 2.5 and 5 part per hundred of PAEK by weight. For instance, 1 gram of graphene was added to 20 grams of PAEK and 180 grams of L2O in order to produce a 5% wt. graphene slurry of 10%/90% PAEK-L20 ratio.

Constituents were put in a closed mixing pot and were mixed using an overhead lab stirrer for 30 minutes at a low speed of 500 rpm followed by 30 minutes of a high speed of 1000 rpm. The slurry is then transferred into a degassing chamber where it is degassed for 1 hr under a vacuum pressure of 0.8 Pa. The slurry is slowly stirred using a magnetic stirrer while being degassed to avoid possible powder settling.

### Prepreg Manufacture

First it is to ensure the surface of the drum is ready for release and is coated with release agent if required. Release agent ensures the prepreg does not stick on the drum after heating melt. While the linear actuator plate is placed far to the right or left of the actuation stoke, S2-glass tow is pulled through all the guides of the prepreg rig and is affixed on the far right or left side of the winding drum via a Kapton tape. The slurry is then added to the resin bath and the fibre spreader is turned on and set as required.

The drum starts revolution and after 2 or 3 rounds, the traverse run (linear actuator) is initiated to process the winding. The speed of the drum and the linear actuator can be adjusted accordingly.

The traverse speed vs the winding speed should regulated to accommodate slight fibre overlap when the winding process begins. This overlap is crucial due to the fact that there are minor changes in the width of fibre tow when reaching the winding drum for processing. Small overlap proves beneficial by not allowing gaps between fibre tows when the winding process initiates. The winding speed shall be selected in a way that the resin slurry does not start to run freely on the winding drum. The spreading/impregnating rollers would squeeze the excess resin off the fibre bundle, however, if very high winding speeds are selected, excess slurry cannot find enough time to drip off the rollers. It is therefore best to set the winding speed first and then adjust the linear motion in conjunction to that.

The traverse speed and the winding speed are measured in % on the controlling device. Both speeds are assigned in percentage with 0% being stop/off and 100% being full speed of the DC motors mounted on the linear actuator (Traverse) and the winding drum (Drum).

Percentage measurements needs to be converted. These percentages should be interpreted in mm/s for the traverse speed and in revolutions per minute (rpm) for winding speed (data not currently available).

After the winding is complete, the traverse motor is turned off and the impregnated fibre tow is cut off from the drum for the final stage of the process, heat melting. The drum is moved towards the end of the prepreg line, where the heating unit is located. The heating unit consists of a ceramic heater and an infrared heater. The rotating drum is firstly positioned above the ceramic heater where the wet prepreg is heated for 4 hours until all the water residues leave the prepreg, to obtain a dry prepreg. After which, the infrared heater is turned on in order to heat melt the PAEK polymer for final consolidation of polymer on the reinforcing fibre. Infrared lamps emit the heat through radiation, meaning they do not need substances like air to act as a heat convector. Infrared lamps emit shorter range wavelength than quarts or ceramic heaters, making them more ideal for heating through radiation. Temperatures on both heaters are adjusted via separate temperature controlling units.

After consolidation, the prepreg is cut from the drum. This is done by cutting the prepreg with a blade along a small groove machined across the whole length of the drum.

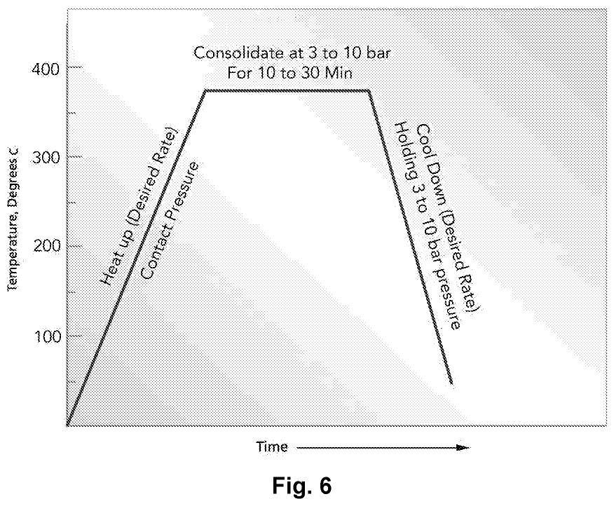

The laminated fibre reinforced composite material was laminated according to the method described with respect to FIG. 6.

FIG. 5A is a photograph of a fibre-reinforced composite material according to exemplary embodiment; and FIG. 5B is a photograph of the laminated fibre-reinforced composite material.

The fibre-reinforced composite material was manufactured as described above.

The laminated fibre reinforced composite material was laminated according to the method described with respect to FIG. 6.

FIG. 6 schematically depicts a method of laminating a fibre-reinforced composite material according to exemplary embodiment.

The fibre reinforced composite material is laminated by press moulding, comprising: heating whilst maintaining contact pressure; consolidating at a temperature of about 375° C. for 10 to 30 minutes at a pressure of 3 to 10 bar; and cooling while maintaining a pressure of 3 to 10 bar.

In more detail, after the prepreg material is ready and is cut from the drum, the pieces can be cut into smaller pieces. Prepreg pieces can be then stacked on each other and heat-pressed to form a composite laminate. Prepregs can be put in any stacking sequence as desired. However, for comparison purposes, all prepregs are put at 0 degree to form a unidirectional laminate. For the purpose of laminating, out-of-autoclave technique was implemented. Prepregs were cut and put into a closed mould and were heat-pressed between to platens. The processing temperature was kept constant at 350° C. Processing pressure varied from 3.5 to 14 bar. The material (mould) is heated to a temperature above the melting point of the resin and then is pressed for 10 to 30 minutes. The laminate is then cooled 5° C./min while maintaining the pressure until it reaches room temperature. After that the mould is opened and the laminate is extracted.

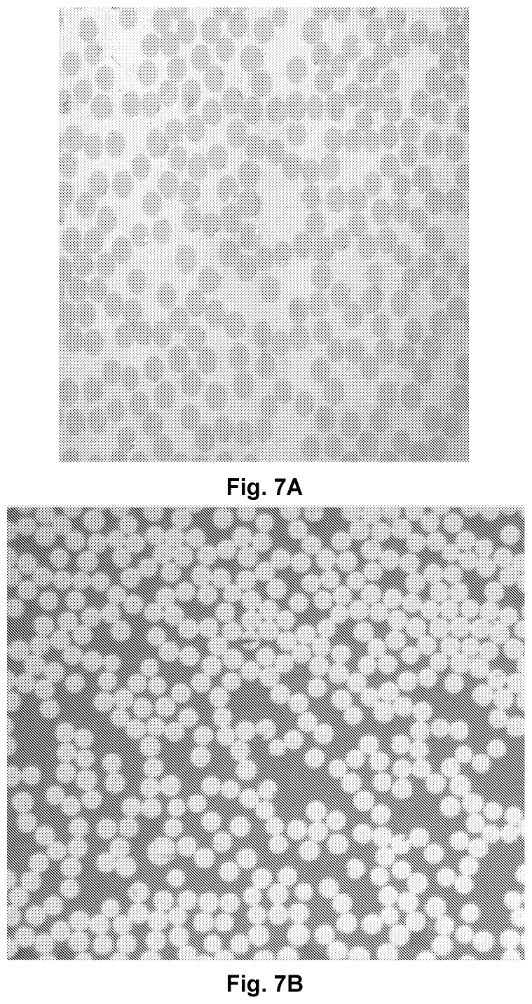

FIG. 7A is a micrograph of a transverse cross-section of a fibre-reinforced composite material according to an exemplary embodiment; and FIG. 7B is a micrograph of a transverse cross-section of a conventional fibre-reinforced composite material, particularly Toray Cetex® TC1200 S2 PEEK (S2-Glass 204 gsm FAW UD Tape Laminate 29% RC having V_{f}=56%), available from Toray Advanced Composites USA (Morgan Hill, CA).

The fibre-reinforced composite material was manufactured as described above.

In contrast to the conventional fibre reinforced composite material, the fibre reinforced composite material according to the exemplary embodiment exhibits full resin impregnation, very low void content, minimum resin reach area and excellent dispersion of fibres.

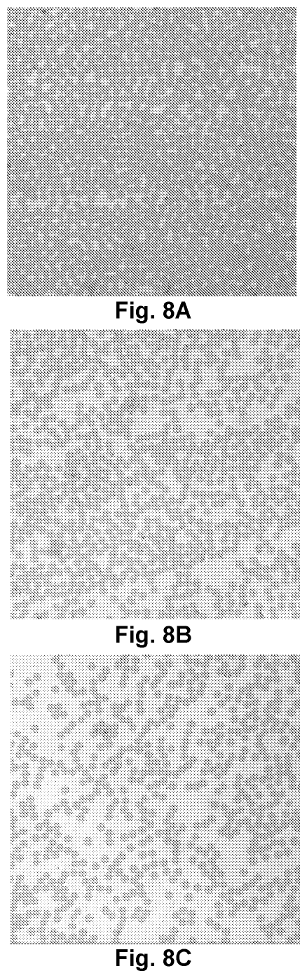

FIG. 8A is a micrograph of a transverse cross-section of a fibre-reinforced composite material according to an exemplary embodiment, having a V_{f}=70%; FIG. 8B is a micrograph of a transverse cross-section of a fibre-reinforced composite material according to an exemplary embodiment, having a V_{f}=47%; and FIG. 8C is a micrograph of a transverse cross-section of a fibre-reinforced composite material according to an exemplary embodiment, having a V_{f}=31%.

The fibre-reinforced composite material was manufactured as described above.

Density of virtually void free and fully consolidated/laminated samples: 30% FV samples˜1.65 g/cm³, 47% FV˜1.84 g/cm³ and 70% FV˜2.13 g/cm³.

TABLE 2
Densities of fibre reinforced composite materials

| | Fibre reinforced composite | |
|---|---|---|
| PAEK in dispersion | material | Density |
| wt. % | V_{f} | g/cm³ |
| 10 | 70 | 2.13 |
| 20 | 46 | 1.84 |
| 30 | 38 | 1.65 |

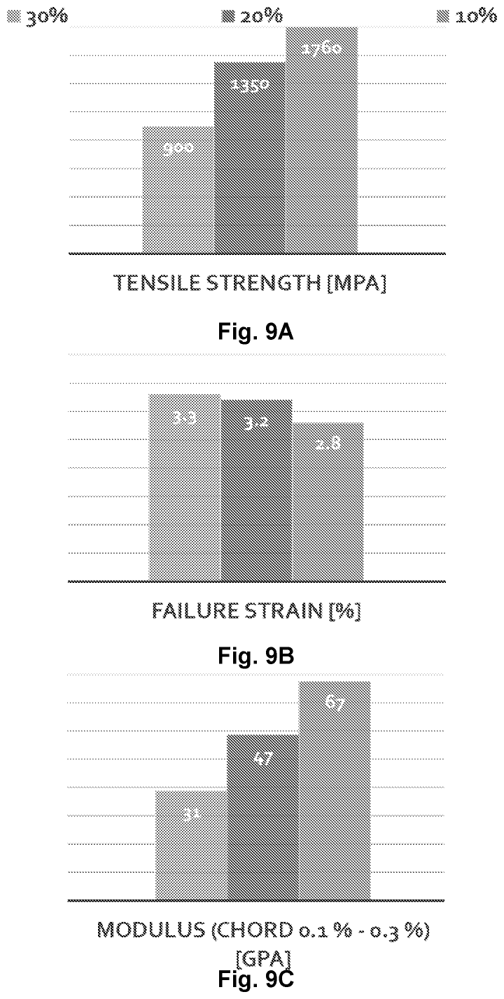

FIG. 9A is a graph of tensile strength of three GF/PAEK fibre-reinforced composite materials according to exemplary embodiments, having V_{f}=70%; V_{f}=46%; and V_{f}=38%, respectively; FIG. 9B is a graph of failure strain of the three GF/PAEK fibre-reinforced composite materials of FIG. 9A; and FIG. 9C is a graph of tensile modulus 0° of the three GF/PAEK fibre-reinforced composite materials of FIG. 9A.

The fibre-reinforced composite material was manufactured as described above.

TABLE 3
Tensile strength, failure strain and tensile modulus 0°

| | Fibre reinforced | | | Tensile |
|---|---|---|---|---|
| PAEK in | composite | Tensile | Failure | modulus |
| dispersion | material | strength | strain | 0° |
| wt. % | V_{f} | MPa | % | GPa |
| 10 | 70 | 1760 | 2.8 | 67 |
| 20 | 46 | 1350 | 3.2 | 47 |
| 30 | 38 | 900 | 3.8 | 31 |

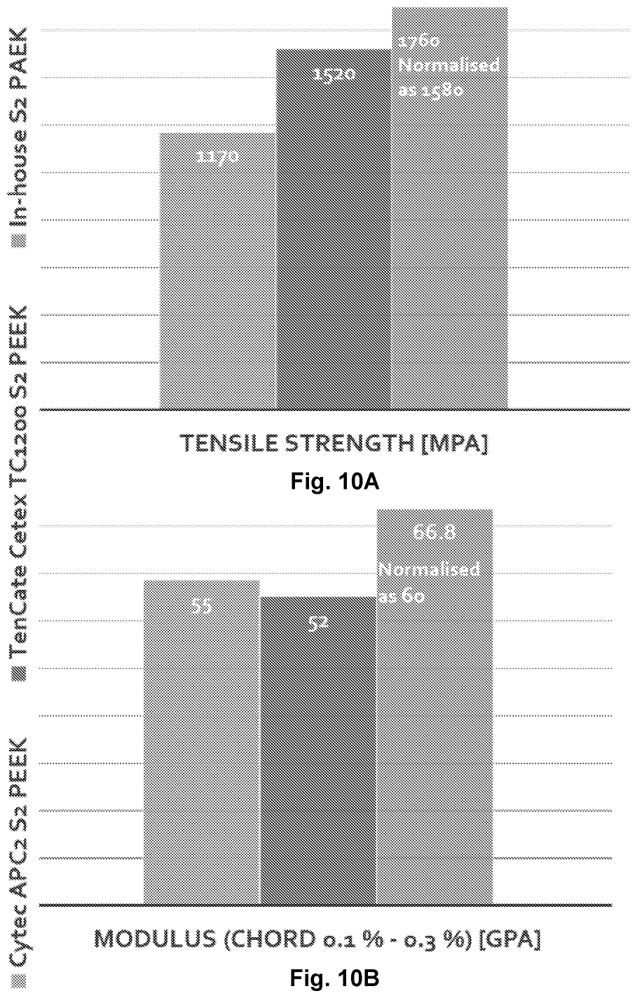

FIG. 10A a graph of tensile strength of two conventional S2/PEEK fibre-reinforced composite materials, specifically Cytec APC-2 S-2 glass fiber reinforced unidirectional tape (product code APC-2/S-2 glass, available from Cytec Solvay Group, Heanor, UK) and Toray Cetex TC1200 S2 PEEK, compared with a S2/PAEK fibre-reinforced composite material according to an exemplary embodiment; and FIG. 10B is a graph of tensile modulus 0° of the two conventional S2/PEEK fibre-reinforced composite materials compared with a S2/PAEK fibre-reinforced composite material according to the exemplary embodiment of FIG. 10A. Cytec APC-2 and Cetex TC1200 S2 PEEK are prepregs, like the S2/PAEK fibre-reinforced composite material according to the exemplary embodiment.

The fibre-reinforced composite material was manufactured as described above.

The tensile strength and the tensile modulus 0° of the S2/PAEK fibre-reinforced composite material according to the exemplary embodiment have been normalised to account for the differences in mechanical properties between PEEK and PAEK and the V_{f} of the S2/PAEK fibre-reinforced composite material.

TABLE 4
Tensile strength and tensile modulus 0°.

| Fibre reinforced | Tensile | Tensile |
|---|---|---|
| composite | strength | modulus 0° |
| material | MPa | GPa |
| Cytec APC-2 | 1170 | 55 |
| S2 PEEK | | |
| Toray Cetex TC1200 | 1520 | 52 |
| S2 PEEK | | |
| S2/PAEK fibre-reinforced | 1580 | 60 |
| composite material | (normalised | (normalised |
| according to the exemplary | from 1760) | from 66.8) |
| embodiment | | |

The tensile strength of the fibre reinforced composite material according to an exemplary embodiment is 35% greater than for APC-2 and 4% greater than for Cetex TC1200. The tensile modulus 0° of the fibre reinforced composite material according to the exemplary embodiment is 9% greater than for APC-2 and 15% greater than for Cetex TC1200. That is, these mechanical properties of the fibre reinforced composite material according to the exemplary embodiment are significantly improved compared with the conventional fibre reinforced composite materials.

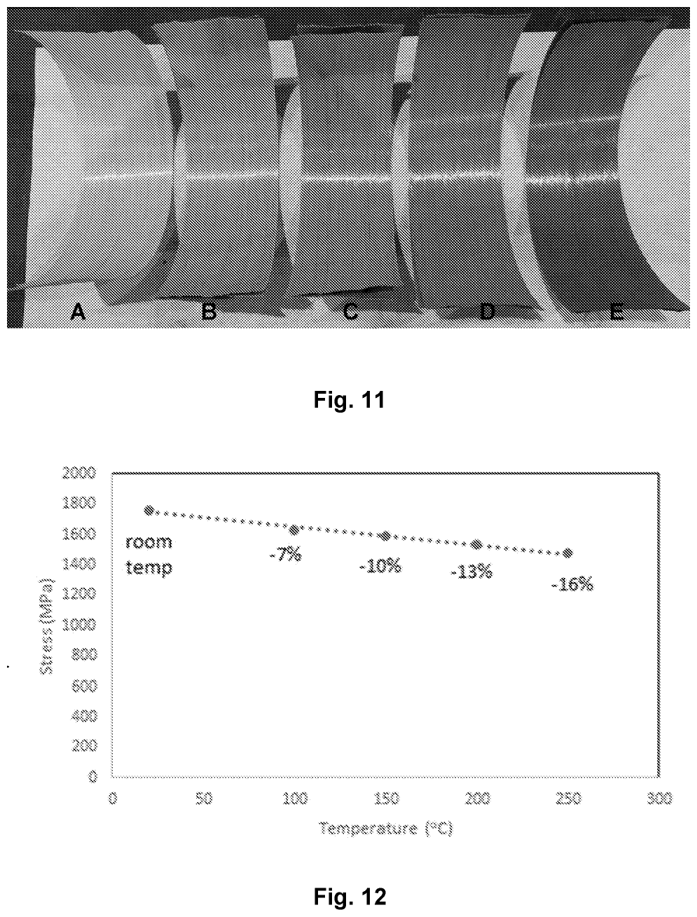

FIG. 11 is a photograph of five fibre-reinforced composite materials according to exemplary embodiments comprising graphene at A: 0.0 wt. %; B: 0.5 wt. %; C: 1.0 wt. %; D: 2.5 wt. %; and E: 5.0 wt. %. wt. % with respect to the particles i.e. the PAEK.

The fibre-reinforced composite material was manufactured as described above.

FIG. 12 is a graph of ultimate tensile strength (UTS) of a fibre reinforced composite material according to an exemplary embodiment as a function of temperature.

The fibre-reinforced composite material was manufactured as described above.

The tensile strengths (UTS) of tensile test specimens of the fibre reinforced composite material, particularly 10% PAEK laminates (70% fibre volume), were tested at five temperatures between room temperature and 250° C., as detailed in Table 3.

TABLE 5
UTS as a function of temperature

| Temperature | UTS | Reduction in |
|---|---|---|
| ° C. | MPa | tensile strength % |
| Room temperature | 1760 | 0 |
| 100 | 1630 | 7 |
| 150 | 1590 | 10 |
| 200 | 1530 | 13 |
| 250 | 1480 | 16 |

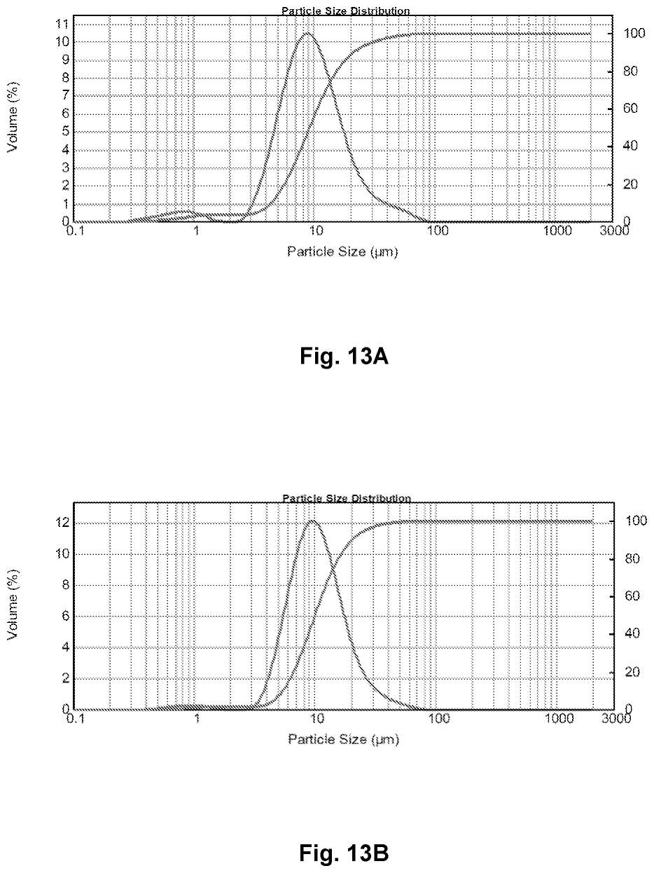

While the tensile strength reduced linearly as a function of temperature, the reduction in tensile strength is significantly less than observed for conventional fibre reinforced composite materials. FIG. 13A is a particle size distribution for particles P1, specifically Victrex PEEK AE250 Grade 20, of a first polymeric composition for a method according to an exemplary embodiment; and FIG. 13B is a particle size distribution for particles P2, specifically Victrex PEEK AE250 Grade of a first polymeric composition for a method according to an exemplary embodiment. Table 6 summarises the particle size distributions for these particles P1 and P2, together with other examples P3 to P7. Particle size distributions were measured using a Malvern Instruments Ltd. Mastersizer 2000, operated according to the manufacturer's instructions, and processed using Mastersizer 2000 Ver. 5.60 software. Particles P1 and, to a lesser extent, particles P2 have a trimodal distribution, including a portion (about 3.5% by volume) of relatively smaller particles (up to 3 μm) and a portion (about 5% by volume) of relatively larger particles (at least 30 μm). Generally, D10 is about 5 μm, D50 is about 10 μm and D90 is about 20 μm.

TABLE 6
D10, D20, D50 and D90 for particles P1 to P7

| | D10 | D20 | D50 | D90 |
|---|---|---|---|---|
| Particles | μm | μm | μm | μm |
| P1 | 4.437 | 5.728 | 9.253 | 21.545 |
| P2 | 5.462 | 6.689 | 10.064 | 20.449 |
| P3 | 4.904 | 6.146 | 9.547 | 19.819 |
| P4 | 5.045 | 6.351 | 9.977 | 21.458 |
| P5 | 5.056 | 6.376 | 10.045 | 21.941 |
| P6 | 4.968 | 6.246 | 9.762 | 20.735 |
| P7 | 4.396 | 5.771 | 9.491 | 22.340 |

### ALTERNATIVES

Although a preferred embodiment has been shown and described, it will be appreciated by those skilled in the art that various changes and modifications might be made without departing from the scope of the invention, as defined in the appended claims and as described above.

### SUMMARY

In summary, the invention provides a design and manufacture of a novel drum winding thermoplastic prepreg rig capable of manufacturing unidirectional thermoplastic prepreg using an aqueous dispersion of thermoplastic powder in a laboratory scale production.

### REFERENCES

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1.-17. (canceled)

18. A PAEK thermoplastic polymer having a median particle diameter (D50) of 1 μm to 100 μm.

19. The PAEK thermoplastic polymer according to claim 18, wherein the D50 is 2.5 μm to 75 μm, such as 5 μm to 60 μm, or 7.5 μm to 15 μm.

20. The PAEK thermoplastic polymer according to claim 18, wherein the particles have a D10 of 4 μm to 6 μm, a D50 of 7 pin to 13 μm, and a D90 of 15 μm to 25 μm.

21. The PAEK thermoplastic polymer according to claim 18, wherein the particles have a D10 of about 5 μm, a D50 of about 10 μm, and a D90 of about 20 μm.

22. The PAEK thermoplastic polymer according to claim 18, wherein the polymer is a PEEK-based copolymer.

23. The PAEK thermoplastic polymer according to claim 18, wherein the tensile elongation of the polymer is about 15%.

24. The PAEK thermoplastic polymer according to claim 18, wherein the flexural strength of the polymer is about 150 MPa.

25. The PAEK thermoplastic polymer according to claim 18, wherein the flexural modulus of the polymer is about 3.3 GPa.

26. A dispersion of a PAEK thermoplastic polymer according to claim 18 in a liquid.

27. The dispersion according to claim 26, wherein the dispersion comprises particles of the PAEK thermoplastic polymer in a range from 2.5 to 50 wt % by weight of the dispersion.

28. A fibre-reinforced composite material comprising a first set of reinforcement fibres, surrounded by a first polymeric composition comprising a PAEK thermoplastic polymer according to claim 18; wherein a volume fraction of the first set of fibres is in a range from 50% to 70% by volume of the composite material.

29. The fibre-reinforced composite material according to claim 28, wherein the median particle diameter D50 of the PAEK thermoplastic polymer is in a range from 0.5d_{f} to 4d_{f}, wherein d_{f} is the diameter of the first set of reinforcement fibres.

30. The fibre-reinforced composite material according to claim 28, wherein the median particle diameter D50 of the PAEK thermoplastic polymer is in a range from d_{f} to 2d_{f}.

31. The fibre-reinforced composite material according to claim 28, wherein the fibre-reinforced composite material has a void volume in a range from 0.001% to 5% by volume of the fibre-reinforced composite material.

32. The fibre-reinforced composite material according to claim 28, wherein the first polymeric composition comprises a filler in a range from 1 wt % to 10 wt % of the composite material.

33. The fibre-reinforced composite material according to claim 32, wherein the filler is a 2D material or a nanoclay.

34. The fibre-reinforced composite material according to claim 33, wherein the filler is graphene.

35. The fibre-reinforced composite material according to claim 28, wherein the fibre-reinforced composite material is a pre-preg.

36. The fibre-reinforced composite material according to claim 28, wherein the fibre-reinforced composite material is a tape, sheet or ribbon.

37. The fibre-reinforced composite material according to claim 36, wherein the fibre-reinforced composite material is a unidirectional tape, a unidirectional sheet, or a unidirectional ribbon.
